(19) United States
(12) Patent Application Publication
(10) Pub. No.: US 2014/0255791 A1
(43) Pub. Date: Sep. 11, 2014

(54) Transparent or Translucent Lithium Ion Battery

(71) Applicant: Nano and Advanced Materials Institute Limited, Hong Kong (HK)

(72) Inventors: Jianying Miao, HK (HK); Wei Li, HK (HK); Shing Hang Ng, HK (HK); King Ho So, HK (HK); Kwok Cheong Lai, HK (HK); Ricky Ka Cheong Luk, HK (HK)

(73) Assignee: Nano and Advanced Materials Institute Limited, Hong Kong (HK)

(21) Appl. No.: 14/187,333

(22) Filed: Feb. 24, 2014

Related U.S. Application Data
(60) Provisional application No. 61/851,408, filed on Mar. 7, 2013.

(51) Int. Cl. H01M 4/76; H01M 10/0565; H01M 2/16

(52) U.S. Cl. CPC H01M 4/76; H01M 2/1673; H01M 10/0565
USPC 429/303; 429/233; 429/245; 429/212

(57) ABSTRACT

The present invention is to provide a transparent/translucent Li-ion battery. The transparent/translucent Li-ion battery comprises an anode, a cathode, and an electrolyte. The anode comprises an electrode material holder with inner structures, a current collector, and an anode material. The current collector is formed along the wall of the inner structures of the electrode material holder, and the anode material is deposited on the current collector, and filled within the inner structures. The cathode is fabricated with the similar method as the anode by using a cathode material. The electrode material holder with the inner structures can be a patterned glass or quartz slice with concave parts, or an anodized aluminum oxide film with channels. The transparent/translucent Li-ion battery of the present invention provides high transparency and electrical storage capacity.

### CROSS REFERENCE TO RELATED APPLICATION

Pursuant to 35 U.S.C. §119(e), this is a non-provisional patent application which claims benefit from U.S. provisional patent application Ser. No. 61/851,408 filed Mar. 7, 2013, and the disclosure of which is incorporated herein by reference.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to a lithium-ion battery, and particularly relates to a transparent or translucent lithium-ion battery, and methods for fabricating said transparent or translucent lithium-ion battery.

### BACKGROUND

Transparent electronics is a key technology for the new generation of electronic and optoelectronic devices. Transparent devices have widely been applied to different applications like optical circuits, touch screens, displays, and solar cells. Furthermore, the market also provides an incentive for electronic companies to launch various transparent devices, such as transparent mobile and transparent display.

Nevertheless, the battery, considered as a major component in electronic devices, has not been adequately demonstrated as a transparent device since many components of the battery such as anode and cathode materials are generally black in color. Hence fully integrated and transparent devices are hardly to be realized because the battery occupies relatively large area and volume in these devices.

One of the conventional methods for fabricating transparent devices is to reduce the thickness of active materials to substantially less than their optical absorption length. Nevertheless, such method is not adequate for batteries, since active battery materials, mostly, do not have an absorption length long enough in the full voltage window. For example, LiCoO₂ and graphite, widely used as the cathode material and anode material in Li-ion batteries, are good light absorbers even with a thickness less than 1 μm. In addition, with such thickness, the battery fails to provide a sufficient amount of energy for storage. Thus, a contradiction appears between the transparency of the battery and the amount of energy stored.

To solve the abovementioned problem, another conventional method is to arrange the electrode materials in a pattern, which occupies merely an areal fraction so that light can transmit freely through the empty space. US2013/0022868 discloses a transparent electrochemical energy storage device, which comprises a pair of electrodes and an electrolyte disposed between the electrodes. Each of the electrodes includes a substrate and a set of electrode materials that are arranged across the substrate in a pattern with a feature dimension no greater than 200 μm and occupy an areal fraction in the range of 5% to 70%. Nevertheless, the transparency and capacity of such energy storage device is low because of poor alignment and packaging.

Consequently, there is an unmet need for a transparent Li-ion battery providing high transparency and adequate energy storage capacity, and being easily manufactured.

### SUMMARY OF THE INVENTION

Accordingly, a first aspect of the presently claimed invention is to provide a transparent or translucent lithium-ion battery, having high transparency and energy storage capacity.

In accordance with an embodiment of the presently claimed invention, a transparent or translucent lithium-ion battery comprises a pair of electrodes including an anode and a cathode, and an electrolyte. The electrolyte is positioned between the anode and the cathode. The anode comprises a first electrode material holder with first inner structures, a first current collector, and an anode material. The first current collector, comprising a first conductive film, is formed along the walls of the first inner structures of the first electrode material holder. The anode material is deposited on the first current collector, and filled within the first inner structures of the first electrode material holder. The cathode comprises a second electrode material holder with second inner structures, a second current collector and a cathode material. The second current collector, comprising a second conductive film, is also formed along the walls of the second inner structures of the second electrode material holder. The cathode material is deposited on the second current collector, and filled within the second inner structures of the second electrode material holder. The first and second electrode material holders are transparent or translucent, thereby leaving the areas of the electrode materials holders without the inner structures for light transmission that makes the lithium-ion battery be transparent or translucent. Preferably, the first electrode material holder with the first inner structures and/or the second electrode material holder with the second inner structures is an anodized aluminum oxide (AAO) film with channels, or a patterned glass/quartz slice with concave parts.

A second aspect of the presently claimed invention is to provide an electrode for a transparent or translucent lithium-ion battery.

The electrode of the presently claimed invention comprises an electrode material holder with inner structures, a conductive film formed along the walls of the inner structures of the electrode material holder, and an electrode material deposited on the conductive film, and filled within the inner structures of the electrode material holder.

In accordance with an embodiment of the presently claimed invention, the electrode of the present invention comprises an AAO film with channels, a conductive film formed along the walls of the channels of the AAO film, and an electrode material deposited on the conductive film, and filled within the channels of the AAO film.

In accordance with another embodiment of the presently claimed invention, the electrode of the present invention comprises a patterned glass/quartz slice with concave parts, a conductive film formed along the walls of the concave parts of the glass/quartz slice, and an electrode material deposited on the conductive film, and filled within the concave parts.

The electrode of the present invention is an anode when the electrode material is an anode material. The electrode of the present invention is a cathode when the electrode material is a cathode material.

A third aspect of the presently claimed invention is to provide methods for fabricating the transparent or translucent lithium-ion battery of the present invention.

The present invention provides a transparent or translucent lithium-ion battery with high transparency and energy storage capacity. Both of the transparency and energy storage capacity are adjustable in a convenient way. In addition, the lithium-ion battery of the present invention is easily assembled and manufactured in a time efficient way.

### BRIEF DESCRIPTION OF THE DRAWINGS

Embodiments of the present invention are described in more detail hereinafter with reference to the drawings, in which:

FIG. 1 is a schematic diagram of a transparent/translucent Li-ion battery according to an embodiment of the presently claimed invention;

FIG. 2 is a flow chart showing the steps of a method for fabricating a transparent/translucent Li-ion battery according to an embodiment of the presently claimed invention;

FIG. 3 shows a set of patterns of a single shape or multiple shapes according to various embodiments of the presently claimed invention;

FIG. 4 is a photo showing a patterned glass slice with patterns of a single shape according to an embodiment of the presently claimed invention;

FIG. 5 is a photo showing a patterned quartz with patterns of multiple shapes according to an embodiment of the presently claimed invention;

FIG. 6 is a flow chart showing the steps of a method for fabricating a patterned glass/quartz slice with concave parts according to an embodiment of the presently claimed invention;

FIG. 7 is a diagram of a full cell of a transparent Li-ion battery with a patterned quartz slice according to an embodiment of the presently claimed invention;

FIG. 8 shows a set of full cells according to various embodiments of the presently claimed invention;

FIG. 9 is a flow chart showing the steps of a method for preparing an AAO film according to an embodiment of the presently claimed invention;

FIG. 10 is a pre-patterned mask for an AAO film with cross-linked aluminum according to an embodiment of the presently claimed invention;

FIG. 11A is a schematic diagram showing an AAO/Al substrate according to an embodiment of the presently claimed invention;

FIG. 11B is a photo of an AAO/Al substrate according to an embodiment of the presently claimed invention;

FIG. 11C-D are scanning electron microscopy (SEM) images showing the surface and the channels respectively of an AAO/Al substrate according to an embodiment of the presently claimed invention;

FIG. 12A-B are schematic diagrams showing transparent AAO films with both open and close ends, and with only open ends respectively according to various embodiments of the presently claimed invention;

FIG. 12C is a photo of a transparent AAO film according to an embodiment of the presently claimed invention;

FIG. 12D is a SEM image showing the surface of a transparent AAO film according to an embodiment of the presently claimed invention;

FIG. 13 show patterned glass slices coated with a gold layer by sputtering according to an embodiment of the presently claimed invention;

FIG. 14 show patterned glass slices coated with platinum with a pre-coated silver layer according to an embodiment of the presently claimed invention;

FIG. 15 shows the concave parts of two patterned glass slices filled by cathode materials respectively according to an embodiment of the presently claimed invention;

FIG. 16A-B are photos showing a separator before and after soaking with electrolyte solution respectively according to an embodiment of the presently claimed invention;

FIG. 17A is a photo showing the transparency of a transparent Li-ion battery with a patterned quartz slice according to an embodiment of the presently claimed invention;

FIG. 17B is an UV-Vis spectrum showing the transmittance of the transparent Li-ion battery of FIG. 17A;

FIG. 18 is a graph showing the relationship between the capacity and the charging and discharging cycles for a transparent Li-ion battery with a patterned quartz slice according to an embodiment of the presently claimed invention; and

FIG. 19 is a graph showing the relationship between the working voltage and the time for a transparent Li-ion battery with a patterned quartz slice according to an embodiment of the presently claimed invention.

### DETAILED DESCRIPTION OF PREFERRED EMBODIMENTS

In the following description, transparent/translucent Li-ion batteries, and the corresponding fabrication methods are set forth as preferred examples. It will be apparent to those skilled in the art that modifications, including additions and/or substitutions, may be made without departing from the scope and spirit of the invention. Specific details may be omitted so as not to obscure the invention; however, the disclosure is written to enable one skilled in the art to practice the teachings herein without undue experimentation.

As used herein, a lithium-ion (Li-ion) battery is defined as a transparent Li-ion battery or a translucent Li-ion battery.

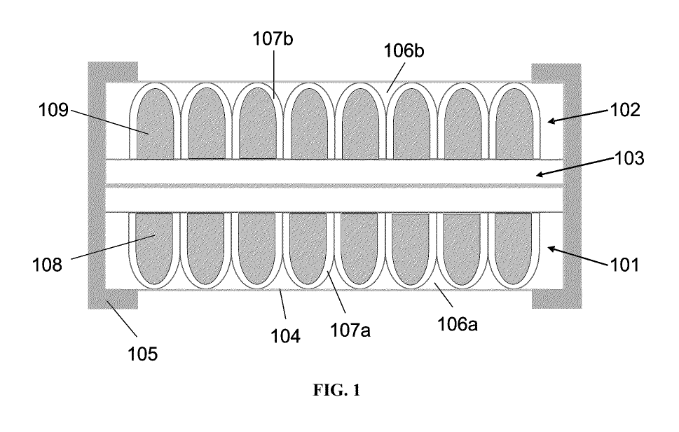

FIG. 1 is a schematic diagram of a transparent/translucent Li-ion battery according to an embodiment of the presently claimed invention. The transparent/translucent Li-ion battery comprises an anode 101, a cathode 102, an electrolyte 103, a protective surface 104, and a sealing material 105. The electrolyte 103 is positioned between the anode 101 and the cathode 102. The protective surface 104 encloses the anode 101, the cathode 102 and the electrolyte 103, and the sealing material 105 is used to seal the lateral sides of the transparent/translucent Li-ion battery.

The anode 101 comprises an electrode material holder 106a with inner structures, a current collector 107a, and an anode material 108. The current collector 107a, comprising nano-sized conductive films, is formed along the walls of the inner structures of the electrode material holder 106a. The anode material 108 is deposited on the current collector 107a, and filled within the inner structures of the electrode material holder 106a.

Similarly, the cathode 102 comprises an electrode material holder 106b with inner structures, a current collector 107b and a cathode material 109. The current collector 107b, comprising nano-sized conductive films, is also formed along the walls of the inner structures of the electrode material holder 106b. The cathode material 109 is deposited on the current collector 107b, and filled within the inner structures of the electrode material holder 106b.

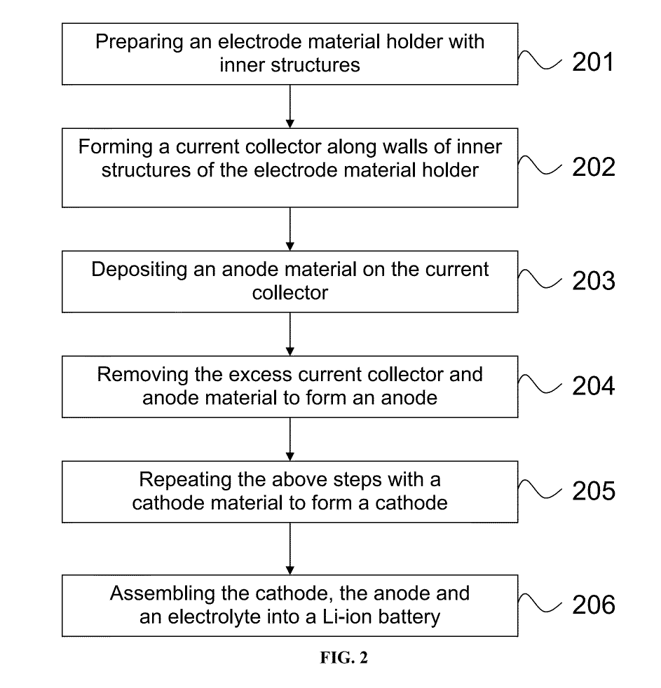

FIG. 2 is a flow chart showing the steps of a method for fabricating a transparent/translucent Li-ion battery according to an embodiment of the presently claimed invention. In step 201, an electrode material holder with inner structures is prepared. In step 202, a current collector is formed along the walls of the inner structures of the electrode material holder. In step 203, an anode material is deposited on the current collector, and filled within the inner structures of the electrode material holder. In step 204, the excess current collector and anode material is removed on the surface of the electrode material holder to form an anode. In step 205, step 201 to step 204 are repeated with a cathode material to form a cathode. In step 206, the cathode, the anode, and an electrolyte are assembled into the transparent/translucent Li-ion battery.

According to an embodiment of the presently claimed invention, the electrode material holder with the inner structures is a patterned glass or quartz slice with concave parts. The patterns of the patterned glass/quartz slice can include a single shape or multiple shapes, providing concave and convex parts of the electrode material holder, which can be changed according to the requirements of transparency and capacitance of the transparent/translucent Li-ion battery. Each of the concave parts has a depth for holding the electrode material as a trench. The current collector is formed along the wall of the concave parts of the patterned glass/quartz slice, and the electrode material is deposited on the current collector, and filled within the concave parts. No matter which pattern/patterns used, the patterned glass/quartz slice also comprises the concave and convex parts. The concave parts of the patterns can have a diameter close to the infinity to form linear trenches.

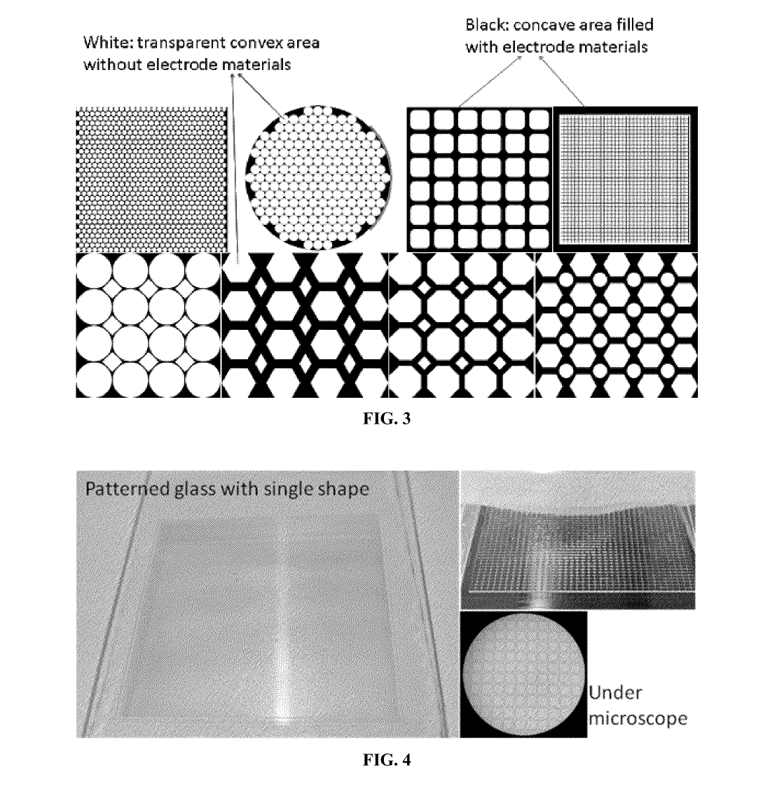

FIG. 3 shows a set of patterns of a single shape or multiple shapes according to various embodiments of the presently claimed invention. The shape can be circular, square, hexagonal, or octagonal. The patterns of multiple shapes can comprise both circular and square shapes. The white parts on the patterns represent transparent convex areas, where no electrode material is filled. The black parts on the patterns represent concave areas, where electrode materials are filled.

FIG. 4 is a photo showing a patterned glass slice with patterns of a single shape according to an embodiment of the presently claimed invention. The patterned glass slice comprises only the patterns of a square shape.

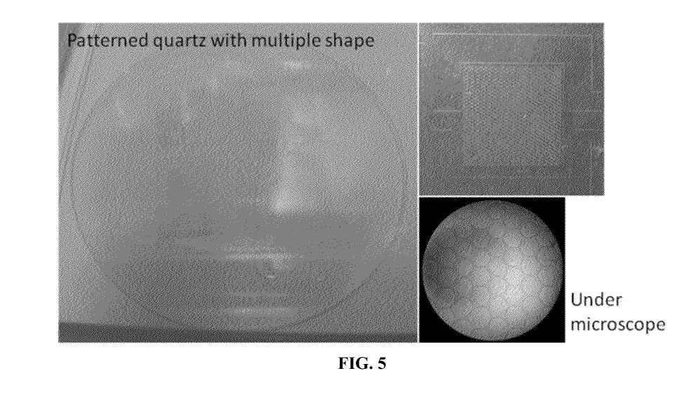

FIG. 5 is a photo showing a patterned quartz slice with patterns of multiple shapes according to an embodiment of the presently claimed invention. The patterned quartz slice comprises the patterns of both circular and hexagonal shapes.

Preferably, the patterns are symmetrical with a single shape or multiple shapes. As the thickness of the patterned glass/quartz slice increases, more electrode materials can be filled in to the electrode material holder to increase the energy storage capacity. Nevertheless, it increases also the cost and thickness of the battery. Thus, the preferable thickness of the patterned glass/quartz slice is in the range of 1 to 5 mm, and the preferable depth of the concave parts is in the range of 70 to 120 μm, depending on the etching method for glass or quartz.

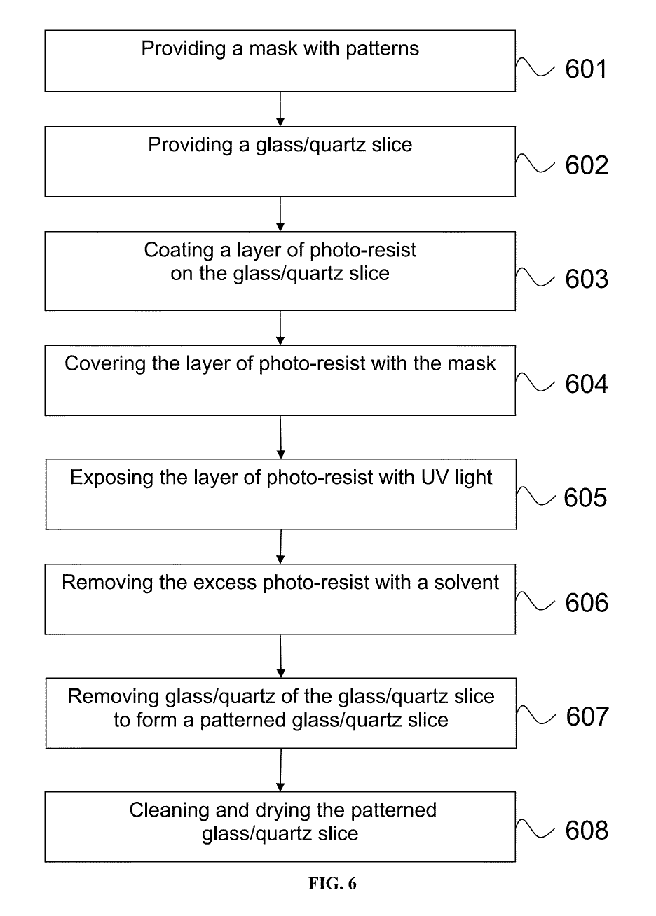

FIG. 6 is a flow chart showing the steps of a method for fabricating a patterned glass/quartz slice with concave parts according to an embodiment of the presently claimed invention. In step 601, a mask with patterns is provided. The patterns of the mask comprise a plurality of patterns providing convex parts and concave parts. In step 602, a glass/quartz slice is provided. The glass/quartz slice can be firstly cleaned and dried. In step 603, a layer of photo-resist is coated on the glass/quartz slice. In step 604, the layer of photo-resist is covered by the mask. In step 605, the layer of photo-resist is exposed to UV light, and is further developed. In step 606, the excess photo-resist is removed by a solvent. In step 607, the glass/quartz of the glass/quartz slice, being not covered by the photo-resist, is removed by dry-etching or wet-etching to form a patterned glass/quartz slice with concave parts. In step 608, the patterned glass/quartz slice with the concave parts is cleaned and dried.

FIG. 7 is a diagram of a full cell of a Li-ion battery with a patterned quartz slice according to an embodiment of the presently claimed invention. The full cell comprises a positioning mark 701, a boundary 702, an outside electrode 703, and a patterned area 704. The positioning mark 701 is for alignment and useful to make the steps of sealing and packaging of the transparent/translucent Li-ion battery become more time efficient and accurate, resulting in less dislocation. The patterned area 704 comprises the concave parts and the convex parts. Preferably, the positioning mark 701 is located on the center line of the patterned area 704, and is large enough to be visible by eyes, but not too large to influence the appearance of the patterned area 704. Any shape, being easily visible and overlapped, such as cross, star, or tick, is applicable.

The boundary 702 comprises different shapes and sizes, and provides the design for the outside electrode 703. In addition, the boundary 702 blocks the outside materials, such as the sealing glue, to affect the inner materials, such as the electrolyte and electrode materials, and makes the patterns be an integrated full cell, which can be modified according to various designs and requirements.

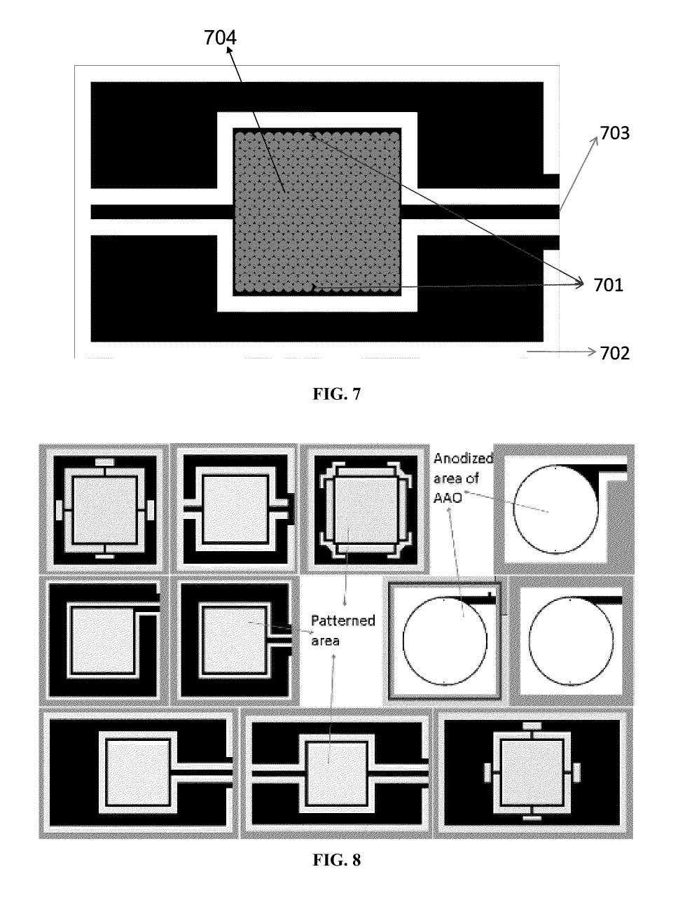

FIG. 8 shows a set of full cells according to various embodiments of the presently claimed invention. The patterned areas of pattern glass/quartz slices and the anodized areas of AAO films are enclosed by the boundary and the outside electrode.

According to an embodiment of the presently claimed invention, the electrode material holder is an anodized aluminum oxide (AAO) film with self-aligned micro/nano-channels. The current collector is formed along the inners wall of the self-aligned micro/nano-channels. The electrode material is deposited on the current collector, and filled within the self-aligned micro/nano-channels.

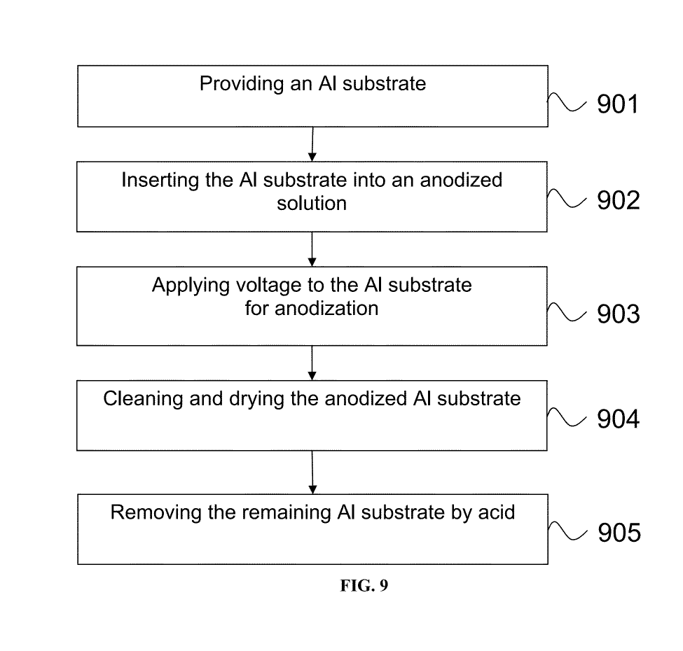

FIG. 9 is a flow chart showing the steps of a method for preparing an AAO film according to an embodiment of the presently claimed invention. In step 901, an aluminum (Al) substrate is provided. The aluminum substrate can be made from pure aluminum or aluminum alloy. Preferably, the Al substrate is firstly degreased, cleaned and dried. In step 902, the Al substrate is inserted into an anodization solution. The anodization solution can be an acid solution or an alkali solution. The acid solution can be a sulfuric acid, a phosphoric acid, an oxalic acid, or a chromic acid. Considering the environmentally friendly issue, sulfuric acid is preferably used. The alkali solution can be sodium hydroxide solution, or potassium hydroxide solution. Different concentrations of the acid or alkali solution can be used with respect to the expected diameter and density of the self-aligned channels of the AAO film.

In step 903, a voltage is applied to the Al substrate for anodization. Direct current is preferably used for anodization. Different voltages are used for different anodization solutions. The voltage is a key factor to influence the expected diameter and density of the self-aligned channels that can be in the range of several volts to several hundred volts. Temperature is another important factor for anodization, which affects not only the expected diameter and density of the channels, but also the uniformity of the channels. Additionally, the length of the channels and the thickness of the AAO film are determined by the anodizing time. According to an embodiment of the presently claimed invention, 0.3M sulfuric acid, voltage of 12 to 18V, and temperature of 12 to 15° C. are used as for anodization.

In step 904, the anodized Al substrate is cleaned and dried. In step 905, the remaining Al substrate is removed by an acid. Preferably, acidic copper sulfate solution is used.

If more uniformly well aligned AAO channels are required, the firstly-made AAO layer on the Al substrate is removed using an acid solution, such as phosphoric acid and chromic acid under the heating of about 60° C. Then, a second AAO layer is further made under the same conditions as those of preparing the first AAO layer.

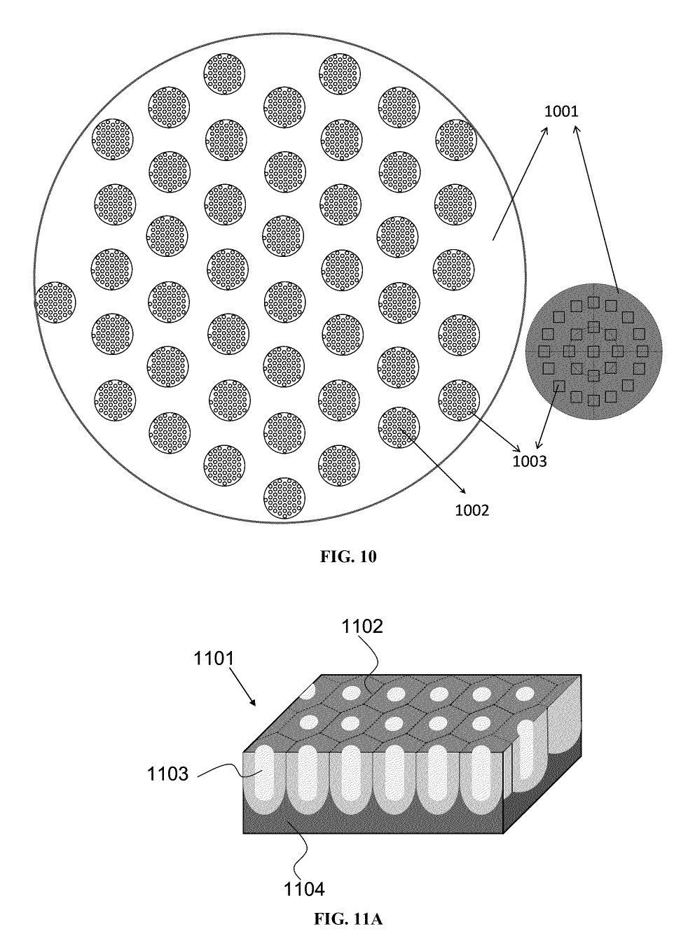

In addition, a pre-patterned mask as shown in FIG. 10 can be used to control the anodization of Al substrate. The pre-patterned mask comprises protection area of Al substrate 1001 and a plurality of anodizing units 1002. The anodizing unit 1002 further comprises a plurality of anodizing areas 1003. Only the portions of the Al substrate under the anodizing areas 1003 are anodized such that other portions of the Al substrate, protected by the mask, are kept non-anodized, resulting in the formation of cross-link areas of aluminum, which form a network to support the AAO film and the outside electrode. Furthermore, the pre-patterned mask is able to control the ratio of the transparent parts to the opaque parts of the Li-ion battery.

Additionally, a transparent thin film such as a thin quartz sheet or a piece of polyethylene terephthalate (PET) can be used to attach on to the AAO film for protection. The transparent thin film can be soft or hard.

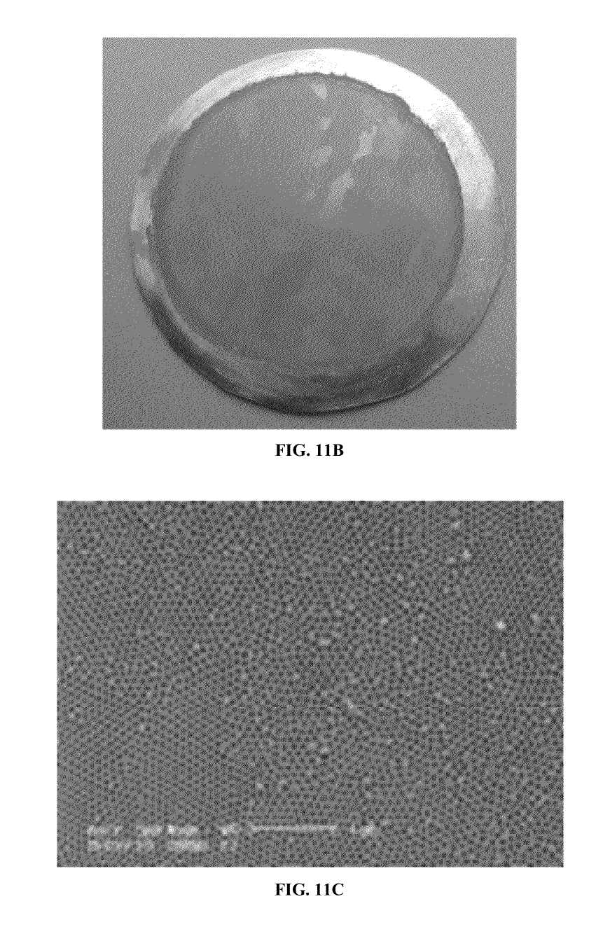

After step 903, the anodized Al (AAO/Al) substrate may not be transparent due to the presence of the remaining Al substrate. FIG. 11A is a schematic diagram showing an AAO/Al substrate according to an embodiment of the presently claimed invention. The AAO/Al substrate 1101 comprises aluminum oxide 1102, self-aligned nano/micro-sized channels 1103, and a remaining aluminum substrate 1104. FIG. 11B is a photo of an AAO/Al substrate according to an embodiment of the presently claimed invention. As shown in the photo of FIG. 11B, the AAO/Al substrates are not transparent. FIG. 11C and 11D are the SEM images showing the surface and the channels respectively of an AAO/Al substrate according to an embodiment of the presently claimed invention.

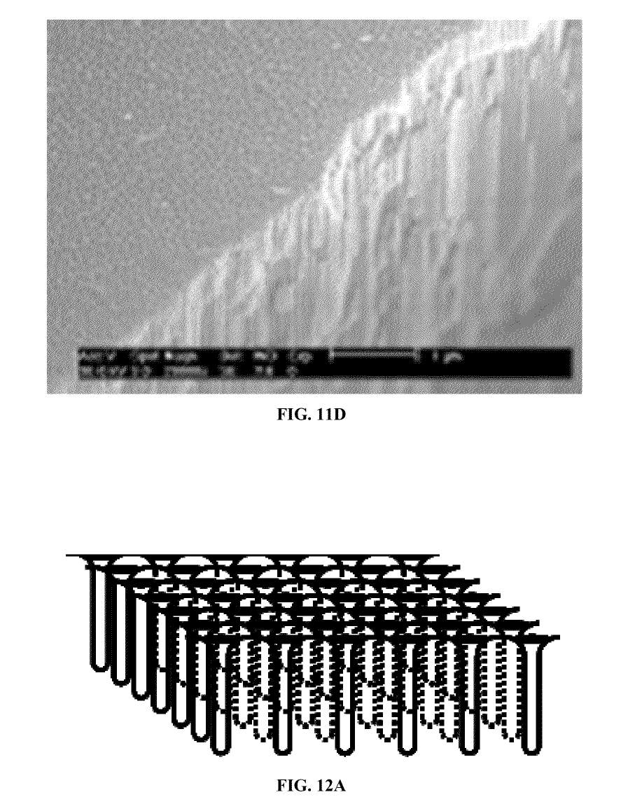

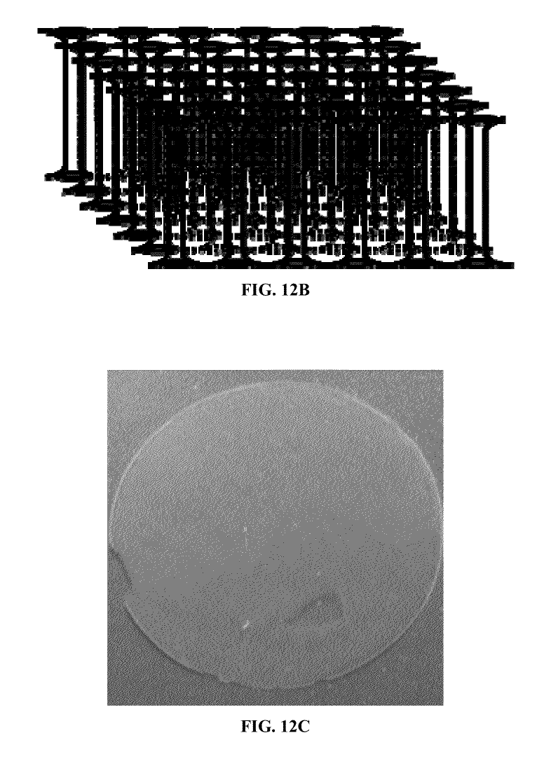

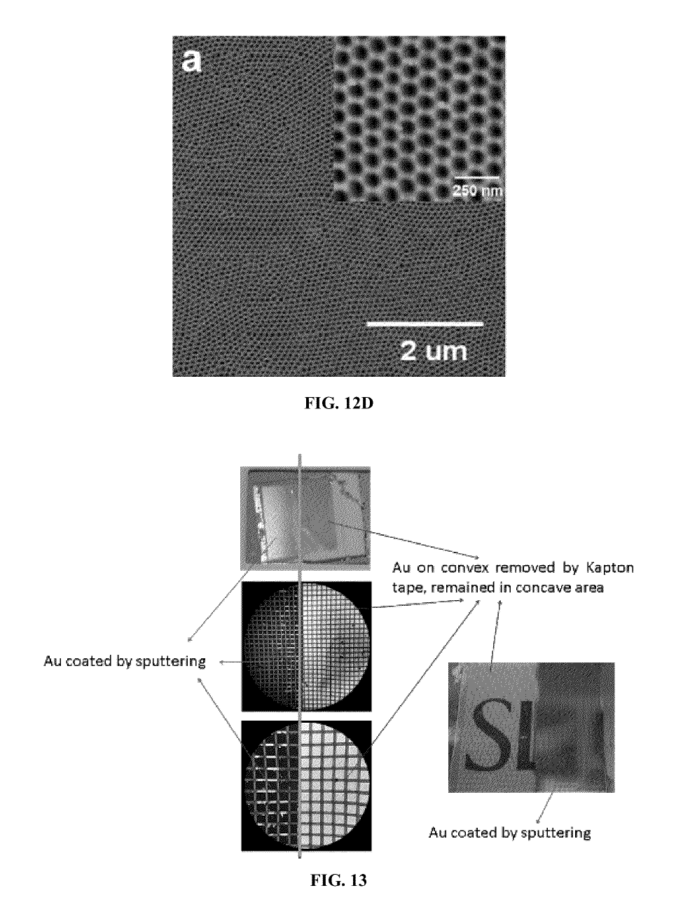

However, after removing the remaining Al substrate from the AAO/Al substrate in step 905, a transparent AAO film with self-aligned nano/micro-sized channels is obtained. FIGS. 12A and 12B are schematic diagrams showing transparent AAO films with both open and close ends, and with only open ends respectively according to various embodiments of the presently claimed invention. FIG. 12C is a photo of a transparent AAO film according to an embodiment of the presently claimed invention. FIG. 12D is a SEM image showing the surface of a transparent AAO film according to an embodiment of the presently claimed invention. The diameters of the channels are about 50-70 nm.

Preferably, the thickness of the AAO film is in the range of 1 to 100 μm for having balance between the energy storage and transparency, and the diameter of the channels of the AAO film is in the range of 3 to 200 nm. Accordingly, the present invention is not limited to the AAO film. Other anodized metal oxide films are also applicable as the electrode material holders. For example, an anodized titanium oxide film can be used.

After the formation of the electrode material holder, nano-sized conductive films, being the current collector, are formed along the walls of the inner structures of the electrode material holder. The nano-sized conductive film can comprise nano-sized metals, nano-sized carbon material, transparent metal oxide, or transparent conductive polymer. The nano-sized metals can be platinum (Pt) or gold (Au). The nano-sized carbon material can be carbon nanotubes (CNTs) or graphene. The transparent metal oxide can be indium (III) oxide (In₂O₃). The transparent conductive polymer can be poly(3,4-alkylenedioxythiophene) (PEDOT), or poly(3,4-ethylenedioxythiophene): poly(styrenesulfonic acid) (PEDOT:PSS). Preferably, the thickness of the nano-sized conductive film is below 50 nm.

The nano-sized metals or the transparent metal oxide can be deposited on the electrode material holder by sputtering or thermal evaporation. FIG. 13 show patterned glass slices coated with a gold layer by sputtering according to an embodiment of the presently claimed invention. The gold layer is firstly coated on the patterned glass slices by sputtering, which is not transparent. The gold layer on the convex parts is then removed by a Kapton tube, thus leaving the convex parts transparent while the gold layer on the concave parts is remained on the patterned glass slices as shown in FIG. 13.

The CNTs or graphene can be fabricated by chemical vapor deposition (CVD). Preferably, the cross-linked CNTs with thin wall are used to achieve better transparency.

The water solution of the transparent conductive polymers of PEDOT or PEDOT:PSS can be filled in to the patterns of the glass/quartz slice (including both convex and concave areas of the pattern), or channels of AAO by brushing. Nano-sized metal particles such as Au and Pt, can be added into PEDOT to enhance the conductivity.

According to an embodiment of the presently claimed invention, the cross-linked CNTs are formed on the walls of the channels of an AAO film as the current collector. Reactants such as organic materials or polymers containing carbon are decomposed with or without catalysts during the heating of the AAO film. The decomposition temperature is about 400-600° C., according to the requirement for conductivity and crystallization of the CNTs. At first, the reactants are sealed in a tube furnace. Inert gases, such as nitrogen or argon, are introduced into the furnace. After a period of time, the furnace is heated to the decomposition temperature. The decomposition temperature is then kept for half an hour to one hour. During cooling down the furnace, an inert gas is kept flowing into the furnace. After the temperature of the furnace drops down to the room temperature, the AAO film coated with the cross-linked CNTs is taken out.

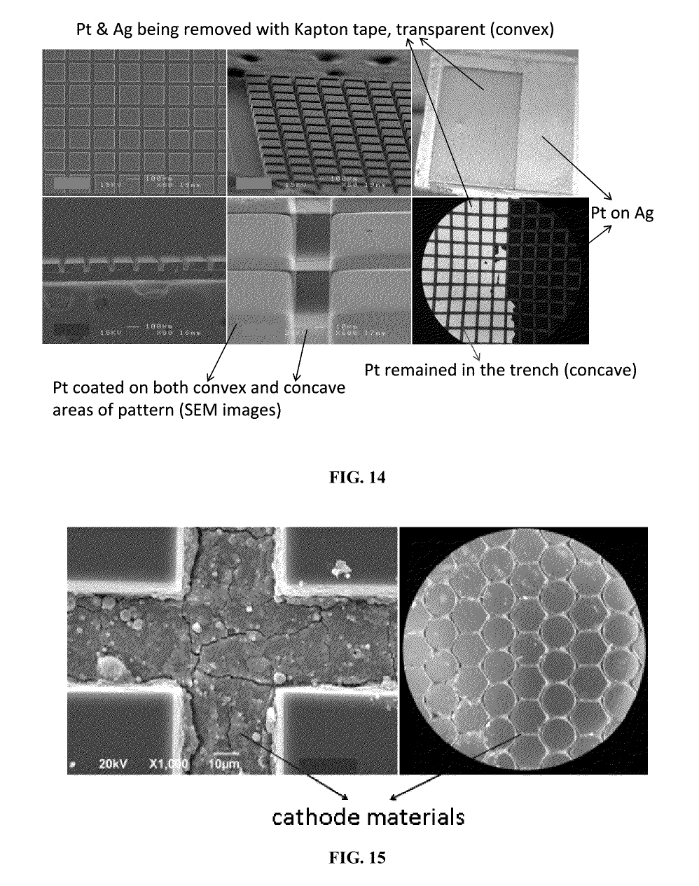

Preferably, a transitional metal layer, such as Ag, is coated on the electrode material holder before coating the conductive material. The transitional metal layer covers only the convex parts of the patterned glass/quartz slice, or the top surface of AAO, because of different surface tension for the convex and concave fields of the pattern, or the top surface and surface of channel wall. In addition, this transitional metal layer can help to remove the excess anode or cathode material together with the conductive material by a glue or tape in a more convenient way. FIG. 14 shows patterned glass slices coated with platinum with a pre-coated silver layer according to an embodiment of the presently claimed invention. The pre-coated silver layer is deposited between the patterned glass slice and the platinum layer. After removing both of the silver and platinum layers on the convex areas with Kapton tape, the platinum layer is remained in the trenches of the patterned glass slice (concave areas).

After the formation of the current collector, a slurry of anode or cathode materials is filled into the patterns of glass/quartz slice (including both convex and concave areas of the patterns), or the channels of AAO film, until that there are enough anode or cathode materials. Then, the anode or cathode materials are dried by heating. Excess anode or cathode materials together with the conductive material on convex areas of patterned glass/quartz slice, or on the top surface of AAO film are removed by a glue or tape, leaving the convex areas, or the area of the AAO film without channels for light transmission.

The slurry of the anode material comprises graphite, carbon black, 1-methyl-2-prrolidone and/or poly(vinylidene fluoride-co-hexafluoropropylene) (PVDF-HFP). The slurry of the cathode material comprises Li-contained materials, such as lithium manganese dioxide (LiMn₂O₄), lithium cobalt oxide (LiCoO₂) and lithium iron phosphate (LiFePO₄), carbon black, PVDF-HFP and 1-methyl-2-prrolidone. FIG. 15 shows the concave parts of two patterned glass slices filled by cathode materials respectively according to an embodiment of the presently claimed invention.

A slim metal sheet is stuck to the location of the outside electrodes on the patterns, and the anode or cathode of the transparent/translucent Li-ion battery is then formed.

A separator is fabricated and further located between the anode and the cathode. The separator is a gel material, such as poly(vinylidene fluoride-co-hexafluoropropylene) (PVDF-HFP). Apart from PVDF-HFP, polyethyleneoxide (PEO), polyacrylonitrile (PAN) or polymethylmethacrylate (PMMA) can also be used as the gel material.

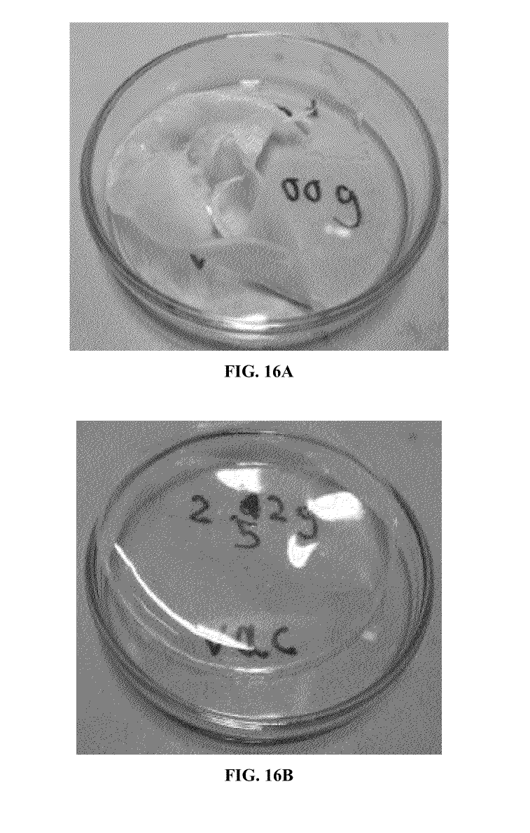

According to an embodiment of the presently claimed invention, PVDF-HFP is prepared as follows. Sylgard 184 silicone elastomer base, Sylgard 184 silicone elastomer curing agent, ethyl acetate and toluene are mixed by stirring or ultrasonicating to form the precursor solution, which is then added into a container. The precursors are dried in an oven to get the solid PVDF-HFP, which is translucent and curved as shown in FIG. 16A. Then, the solid PVDF-HFP is immersed into the solvent of electrolyte solution, such as diethyl carbonate (DEC), dimethyl carbonate/ethylene carbonate (DMC/EC), diethyl carbonate/ethylene carbonate (DEC/EC), or Poly(vinylidene fluoride-hexafluoropropylene). After soaking the solvent, the separator becomes transparent and flat as shown in FIG. 16B. After removing the excess solvent by a tissue, no apparent or excess liquid on the separator can be seen or felt.

According to an embodiment of the presently claimed invention, a full cell of the transparent Li-ion battery is packaged as follows. At first, a semi-dried separator is cut to a suitable size, and is sandwiched between a patterned anode and cathode. The anode and cathode are aligned by a positioning mark in the pattern. The anode, separator and cathode are fixed by clips or any other fixer that can be completed by naked eyes or under a microscope. Transparent UV glue is injected around the anode and/or cathode. Most of the boundary area around the patterned fields is filled with the UV glue. The UV glue is then cured using UV light.

The full cell is further packaged in a glove box. An electrolyte solution is introduced into the separator from the boundary without sealing by the UV glue. The electrolyte solution can be a solution of lithium hexafluorophosphate (LiPF₆), lithium hexafluoroarsenate (LiAsF₆), lithium tetrafluoroborate (LiBF₄), lithium trifluoromethanesulfonate (LiCF₃SO₃), Lithium bis(trifluoromethanesulfonyl)imide (LiTFSI), or lithium perchlorate (LiClO₄) in a solvent of DEC, DMC/EC, DEC/EC, or poly(vinylidene fluoride-hexafluoropropylene). The UV glue is injected again to the remaining boundary of the whole battery, which is not sealed by the UV glue in the previous steps. The UV glue is cured with UV light. Finally, a transparent/translucent Li-ion battery is obtained.

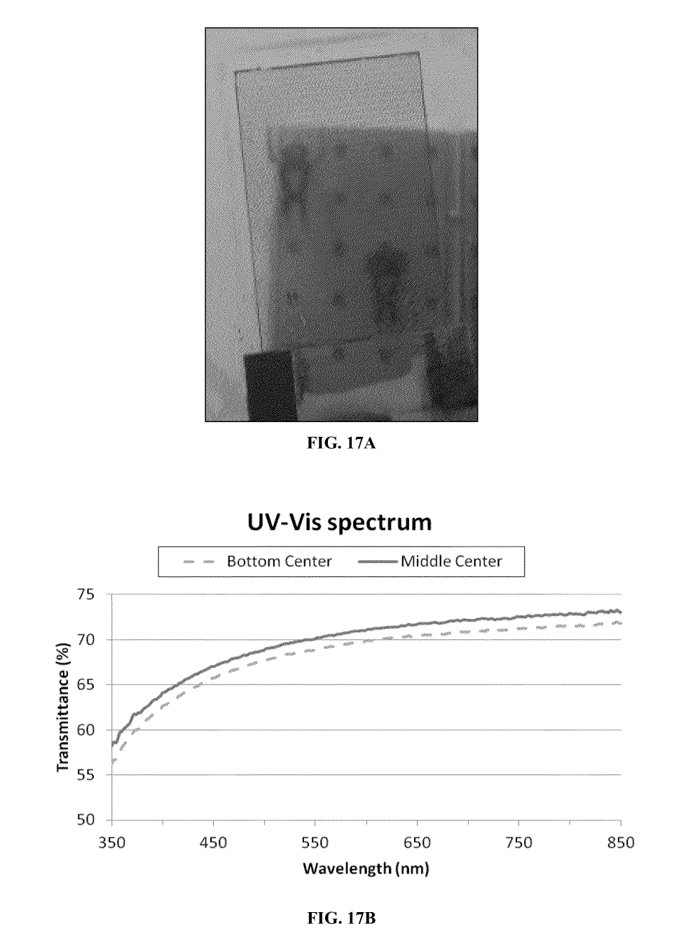

FIG. 17A is a photo showing the transparency of a transparent Li-ion battery with a patterned quartz slice according to an embodiment of the presently claimed invention. FIG. 17B is an UV-Vis spectrum showing the transmittance of the transparent Li-ion battery of FIG. 17A. The dotted line represents the transmittance measured at the bottom center of the transparent Li-ion battery. The solid line represents the transmittance measured at the middle center of the transparent Li-ion battery. The transmittance of the transparent Li-ion battery sample shown in FIG. 17A is about 57% to about 73% within the wavelengths of visible light ranging from 380 to 780 nm.

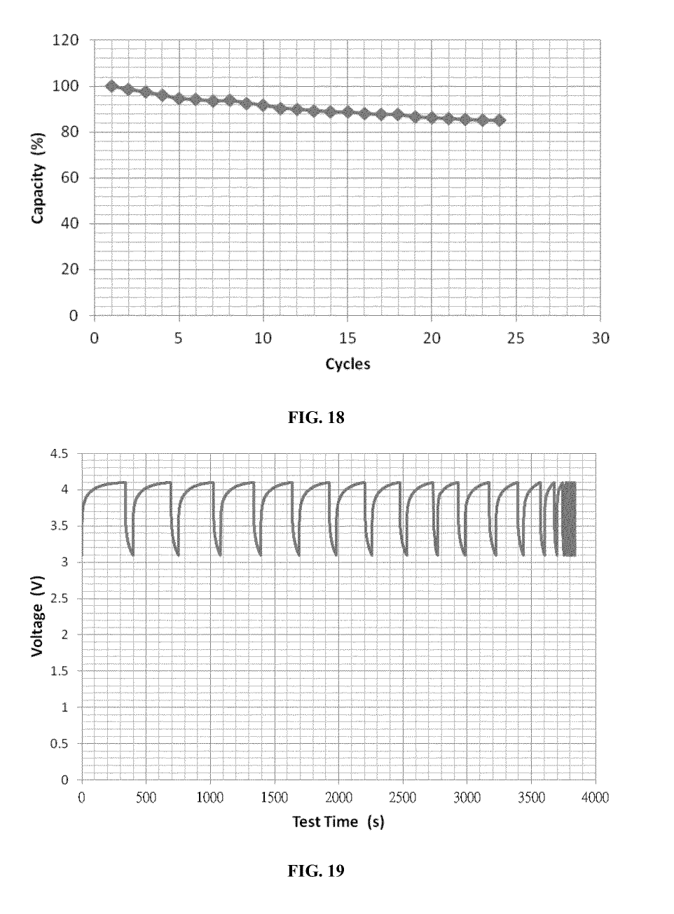

FIG. 18 is a graph showing the relationship between the capacity and the charging and discharging cycles for a transparent Li-ion battery with a patterned quartz slice according to an embodiment of the presently claimed invention. As shown in the graph, only 15% of the capacity is dropped after 24 charging and discharging cycles.

FIG. 19 is a graph showing the relationship between the working voltage and the time for a transparent Li-ion battery with a patterned quartz slice according to an embodiment of the presently claimed invention. The charge and discharge current is at a constant value of 0.2 mA, the working voltage is in the range of 3.1 to 4.1V, and the efficient area of the Li-ion battery is 2.79 cm². This graph shows that the transparent Li-ion battery of the present invention can be charged and discharged.

In order to increase the capacity of the whole battery, similar full cells packaged as mentioned above can be stacked up. Owing to the clear positioning mark and boundary, this step is not difficult to be achieved.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. An electrode for a transparent or translucent lithium-ion battery, comprising:
at least one electrode material holder with one or more inner structures;
at least one conductive film formed along one or more walls of the inner structures of the electrode material holder; and
at least one electrode material deposited on the conductive film, and filled within the inner structures of the electrode material holder.

2. The electrode of claim 1, wherein the electrode material holder with the inner structures is transparent or translucent.

3. The electrode of claim 1, wherein the electrode material holder with the inner structures is an anodized aluminum oxide (AAO) film with one or more channels.

4. The electrode of claim 3, wherein each of the channels is self-aligned in micro- or nano-size.

5. The electrode of claim 3, wherein the conductive film comprises cross-linked carbon nanotubes formed along the walls of the channels of the AAO film.

6. The electrode of claim 1, wherein the electrode material holder with the inner structures is an anodized metal oxide film with one or more channels.

7. The electrode of claim 1, wherein the electrode material holder with the inner structures is a patterned glass or quartz slice with one or more concave parts.

8. The electrode of claim 7, wherein each of the concave parts comprises a diameter close to infinity.

9. The electrode of claim 1, wherein the conductive film comprises at least one nano-sized metal, at least one nano-sized carbon material, at least one transparent metal oxide, or at least one transparent conductive polymer.

10. The electrode of claim 9, wherein the at least one nano-sized metal comprises platinum or gold; the at least one nano-sized carbon material comprises carbon nanotubes or graphene; the at least one transparent metal oxide comprises indium (III) oxide; and the at least one transparent conductive polymer comprises poly(3,4-alkylenedioxythiophene), or poly(3,4-ethylenedioxythiophene): poly(styrenesulfonic acid).

11. The electrode of claim 1, wherein the electrode material holder further comprises at least one positioning mark for alignment.

12. The electrode of claim 1, wherein the electrode material is an anode material or a cathode material.

13. The electrode of claim 1, further comprising at least one pre-coated silver layer between the wall of the inner structures and the conductive film.

14. A transparent or translucent lithium-ion battery, comprising:
a pair of electrodes, wherein at least one of the pair of the electrodes is realized as the electrode of claim 1; and
at least one electrolyte.

15. The battery of claim 14, further comprising:
a separator, wherein the separator comprises at least one gel material, soaked with at least one solvent of the electrolyte;
wherein the electrolyte is enclosed in the separator; and
wherein the separator is located between the pair of the electrodes.

16. The battery of claim 15, wherein the gel material comprises poly(vinylidene fluoride-co-hexafluoropropylene), polyethyleneoxide, polyacrylonitrile, or polymethylmethacrylate.

17. A transparent or translucent lithium-ion battery, comprising:
a pair of electrodes, wherein at least one of the pair of the electrodes is realized as the electrode of claim 3; and
at least one electrolyte.

18. The battery of claim 17, further comprising:
a separator, wherein the separator comprises at least one gel material, soaked with at least one solvent of the electrolyte;
wherein the electrolyte is enclosed in the separator;
wherein the separator is located between the pair of the electrodes; and
wherein the gel material comprises poly(vinylidene fluoride-co-hexafluoropropylene), polyethyleneoxide, polyacrylonitrile, or polymethylmethacrylate.

19. A transparent or translucent lithium-ion battery, comprising:
a pair of electrodes, wherein at least one of the pair of the electrodes is realized as the electrode of claim 7; and
at least one electrolyte.

20. The battery of claim 19, further comprising:
a separator, wherein the separator comprises at least one gel material, soaked with at least one solvent of the electrolyte;
wherein the electrolyte is enclosed in the separator;
wherein the separator is located between the pair of the electrodes; and
wherein the gel material comprises poly(vinylidene fluoride-co-hexafluoropropylene), polyethyleneoxide, polyacrylonitrile, or polymethylmethacrylate.
